(19) United States
(12) Patent Application Publication
(10) Pub. No.: US 2003/0116935 A1
(43) Pub. Date: Jun. 26, 2003

(54) Anti-roll vehicle suspension

(76) Inventor: Adam Zadok, Cicero, IL (US)

Correspondence Address: FRELING E. BAKER, Suite 203, 12625 HIGH BLUFF DRIVE, SAN DIEGO, CA, 92130, US

(21) Appl. No.: 10/033,288

(22) Filed: Dec. 26, 2001

(51) Int. Cl. B60G 1/00

(52) U.S. Cl. 280/124.106

(57) ABSTRACT

An antiroll suspension for a vehicle chassis having laterally spaced wheels, the suspension comprises an axle assembly for rotatably mounting each of a pair of laterally spaced wheels, a spring assembly supporting the chassis on each of the axle assemblies, a moveable arm connected between the spring and the chassis, and an anti roll linkage connected between said chassis and the moveable arm of the axles of the suspension system being responsive to a lateral force on said chassis, and structured to translate lateral force on the chassis to a vertical force on the down force side of the chassis so that the anti roll linkage simultaneously lift the down force side of the vehicle and lower the up force side of the vehicle.

### BACKGROUND OF THE INVENTION

1. Field of the Invention

The present invention relates generally to vehicle suspension systems, and pertains more particularly, to an automotive suspension system with means for limiting vehicle body roll by utilizing the inertial forces on the vehicle chassis to load the download side of the suspension.

2. Discussion of the Related Art

A typical automotive vehicle has a body or chassis formed with an enclosed operator and passenger compartment with the body being resiliently supported by a suspension system on wheel assemblies that carry it over a generally horizontal road or street surface. The suspension isolates the vehicle body from vibration and impacts resulting from the wheels traveling over rough road surfaces. The suspension system typically employs springs, which support the body on the wheel assemblies and with damping means, which acts to dampen oscillations and movements of the wheel assemblies relative to the body. The vehicle typically has steerable front wheels and nonsteerable rear wheels.

The construction of a suspension system is often a compromise between a soft suspension for providing a soft or relatively smooth ride for passenger comfort over rough roads and the like and a stiff suspension which enhances the safety and stability of the vehicle. A stiffer suspension offers less comfort to passengers but increases the stability of the vehicle by resisting roll or sway of the body on the suspension. When the typical vehicle enters a turn the resulting centrifugal forces acting on the vehicle tend to roll the vehicle body about its center relative to the underlying suspension system. This centrifugal force also tends to displace the body laterally, outwardly tending to cause the vehicle to pivot about the contact of its outer wheels with the road surface.

The construction of a vehicle body and the configuration of the vehicle suspension systems determine the location of the roll center. In a conventional vehicle, the roll center of the vehicle is typically below the center of gravity of the vehicle. Centrifugal forces tending to roll the vehicle body act on a lever arm or through a lever arm determined by the vertical distance between the center of gravity and the roll center. This is known as the roll couple.

As a vehicle body moves through a turn the body tends to roll and shift the weight onto the outer suspension and wheels while simultaneously unloading the inner suspension springs and wheels thereby reducing the cornering attraction of the vehicle. The body also tilts or rolls toward the outside of the curve shifting the center of mass of the vehicle toward the outside suspension and wheels.

The rolling of the vehicle body about its roll center when negotiating a turn is discomforting to the operator and to passengers. Stiffer suspensions which tend to reduce this tendency to roll has the disadvantage of subjecting the passengers and operator to the jolting and jarring of rough roads. A number of approaches to over coming this tendency of the vehicle to roll during cornering have been proposed in the past. One approach has been to provide the vehicle with a linkage system powered by electric motors to selectively tilt the body inwardly during cornering. Such a system is disclosed in U.S. Pat. No. 2,152,938.

Other attempts at solving the cornering problems have provided for the wheels of the vehicle to tilt into a curve. These have been powered by various means such as electrical and hydraulic systems. One such system that is powered or controlled by the steering of the vehicle is disclosed in U.S. Pat. No. 2,787,473. These systems are generally complicated and expensive.

Others have attempted to overcome this problem by designing the suspension system so that the roll center of the vehicle is disposed above its center of its gravity. Most of these systems are also complicated and expensive and have other serious drawbacks.

Accordingly there is a need for an improved anti roll suspension system that over comes the above problems of the prior art.

### SUMMARY OF THE INVENTION

The present invention solves the problem of excessive vehicle body roll by providing a suspension system having a linkage that translates lateral body movement into a lift force on the down load side of the body. More specifically, one embodiment of the invention comprises an anti roll suspension for a vehicle chassis having at least two laterally spaced wheels, wherein the suspension comprises an axle assembly for rotatably mounting each of a pair of laterally spaced wheels, a spring assembly supporting the chassis on each of the axle assemblies, a moveable arm connected between the spring and the chassis, and an anti roll linkage connected between said chassis and the moveable arm of the axles of the suspension system being responsive to a lateral force on said chassis, and structured to translate lateral force on the chassis to a vertical force on the down force side of the chassis so that the anti roll linkage simultaneously lift the down force side of the vehicle and lowers the up force side of the vehicle. However, the claims alone, not the preceding summary, define the invention.

### BRIEF DESCRIPTION OF THE DRAWINGS

The nature, goals, and advantages of the invention will become more apparent to those skilled in the art after considering the following detailed description when read in connection with the accompanying drawing—illustrating by way of examples the principles of the invention—in which like reference numerals identify like elements throughout wherein:

FIG. 1 is an elevation view from the rear of one embodiment of the invention showing a vehicle body in phantom in a static condition;

FIG. 2 is a top plan view of the embodiment of FIG. 1;

FIG. 3 is a perspective view of the embodiment of FIG. 1;

FIG. 4 is a view like FIG. 1 showing the condition of the suspension with the vehicle in a turn;

FIG. 5 is a view like FIG. 4 of another embodiment of the invention;

FIG. 6 is a top plan view of the embodiment of FIG. 5;

FIG. 7 is a perspective view of a further embodiment of the invention; and

FIG. 8 is a view like FIG. 5 showing the condition of the suspension of FIG. 7 with the vehicle in a turn.

It will be recognized that some or all of the figures are schematic representations for purposes of illustration and do not necessarily depict the actual relative sizes or locations of the elements shown.

### DETAILED DESCRIPTION OF THE PREFERRED EMBODIMENTS

In the following paragraphs, the present invention will be described in detail by way of example with reference to the attached drawings. In the description, the parts and components of the present invention, which are the same, will be referred to by the same or similar reference symbols, and specific description therefor may be omitted.

Unless defined otherwise, all technical and scientific terms used herein have the same meaning as is commonly understood by one of skill in the art to which this invention belongs. In event the definition in this section is not consistent with definitions elsewhere, the definitions set forth in this section will control.

Throughout this description, the preferred embodiment and examples shown should be considered as exemplars, rather than as limitations on the present invention. As shown in the drawing for purposes of illustration, a suspension system according to the invention provides a rapid loading of the down load side springs in response to a lateral force on the vehicle chassis such as in a turn to reduce or eliminate roll of the vehicle body. A suspension system according to the invention provides a more comfortable ride for operator and passengers by reducing or eliminating roll of the body. It also provides a more stable vehicle by reducing or eliminating roll of the body as the vehicle negotiates turns. The suspension system of this invention is also simple and easily fabricated and installed with little or no alteration in existing vehicle design.

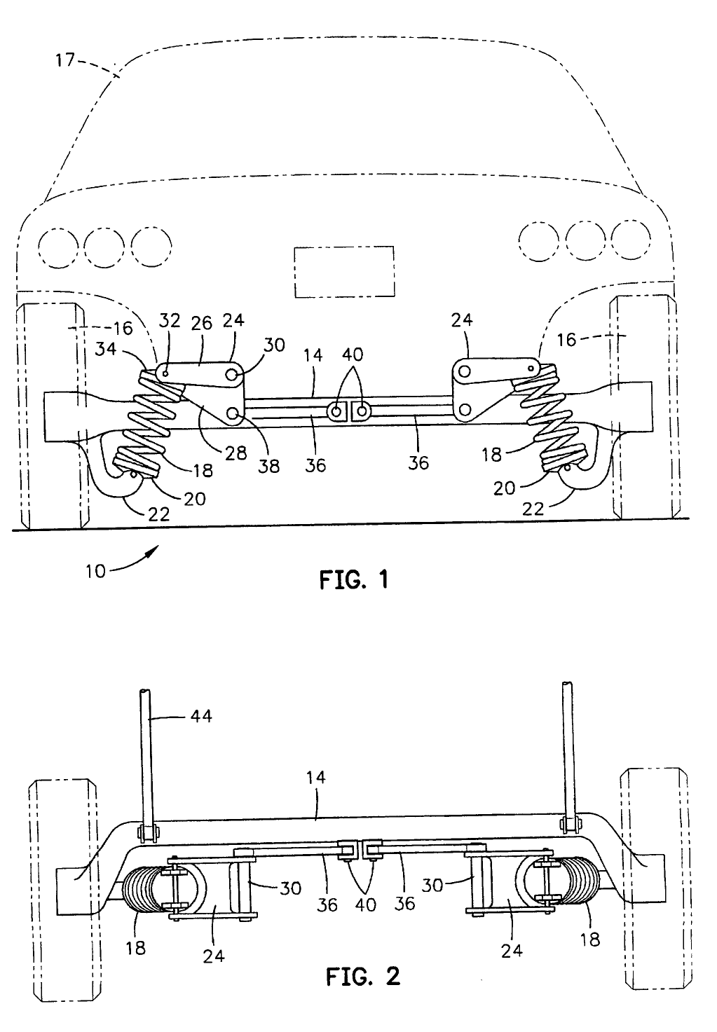

Referring to FIG. 1, an anti-roll suspension system in accordance with one embodiment of the invention is illustrated and designated generally by the numeral 10. The suspension system is shown supporting the rear of a typical automotive vehicle with the vehicle chassis or body 12 shown in phantom in a neutral or stable condition. The anti-roll suspension system is devised for a vehicle chassis having at least two laterally spaced wheels. The vehicle may have only two wheels such as a tow able trailer or it may have more such as an automobile or other motorized vehicle.

The suspension system as illustrated comprises an elongated solid axle 14 having an axle assembly on each end for rotatably mounting each of a pair of laterally spaced wheels 16. While the axle is illustrated as being a non-driving axle, it may be a driving axle as used on most trucks and many automobiles. The vehicle chassis 12 is supported on the axle by a suspension system comprising a pair of springs 18, each secured at a lower end by a bracket 20 on a an arm 22 of axle 14. The springs are illustrated as coil compression springs disposed in a somewhat vertical orientation, but may be other type as will be appreciated. The springs may also have other orientations such as horizontal, either in a transverse or an axial direction, as in many race type cars.

An upper end of each spring is attached or coupled to the chassis by a moveable lever or arm 24 connected between the spring and the chassis. The lever 24, as illustrated is a bell crank having a long arm 26 and a short arm 28, and is pivotally attached at its main fulcrum point to the chassis by a pin 30. The longer arm 26 of lever or bell crank 24 is pivotally attached by a pin 32 to a spring bracket 34 secured to the top of spring 18. The short arm is connected or attached by an anti roll actuating or compensating link 36 that is connected to arm 28 of bell crank 24 by pivot pin 38 and to the axle by pivot pin 40. This link also serves as a panhard link that normally limits lateral shifting of the vehicle chassis relative to the axle.

In the instant system link 36 serves to translate a movement of the chassis and the moveable arm of the axles of the suspension system to a vertical force on the down force side of the chassis so that the anti roll linkage simultaneously lift the down force side of the vehicle and lower the up force side of the vehicle. As will be appreciated, the chassis shifts outward to the outside of a curve under centrifugal force as much as will be allowed by pivoting of links levers 24 as they rotate as will be described with respect to FIG. 4.

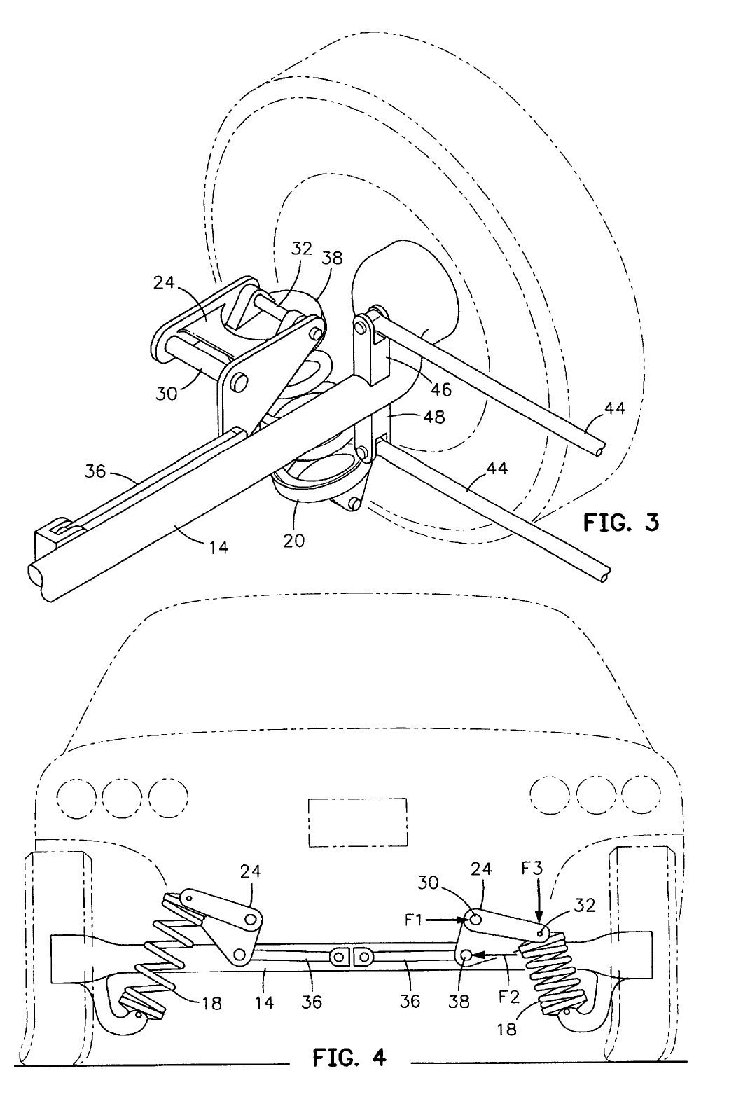

Referring now to FIGS. 2 and 3 it is seen that the axle 14 is offset in the center section from the wheel or hub mounting portions. The axle is also connected to the chassis of the vehicle by means of a pair of links 44 connected to upper and lower respective arms 46 and 48 secured to the axle adjacent the wheel end of the axle. This connection is essentially a four-bar linkage and allows the axle to rise and fall independently of the chassis and connects the axle to move fore and aft with the chassis.

As best seen in FIG. 2 the spring mounting to the axle is in line with the rotary axis of the wheels and positions the springs substantially vertically with a slight inward angle or incline. The levers or bell cranks 24 are constructed to have a width about that of the spring and is shown to be constructed of a pair of laterally spaced arms interconnected by a web or plate. The shorter arm of lever 24 is shown to be constructed or formed by a single one of the arms or plates whereas the longer arm extends over and encompasses the spring. As will be appreciated, this type of assembly with a substantially rigid axle may be utilized in any number of vehicles such as the axle of a trailer or rear axles of front wheel driven autos and trucks or rear axles of trucks. While the illustrated axle is shown as a non-drive axle, the suspension obviously can be utilized on a driven axle such as the rear axle of an automobile or truck. The axle may also be steerable without affecting the action of the suspension.

Referring now to FIG. 4 the action of the suspension system of the present invention in a turn is illustrated. As shown the rear view of a vehicle in a severe left turn is illustrated with the chassis shifted to the right relative to the axle and wheels of the vehicle. This movement of the vehicle chassis actuates the linkage with the movement translated by the linkage to action on the springs and a resultant maintenance of the chassis in a level condition. As will be appreciated the center of mass of the vehicle body or chassis will be above the center of axle 14 and in a severe left-hand turn as illustrated will shift to the right and will also tend to roll clockwise about it's center of rotation. The center of rotation may not be located at the center of mass of the chassis but it most likely will be below the center of mass.

The movement of the vehicle into a turn as illustrated will result in the body or chassis shifting to the right relative to the axle of the vehicle thereby imposing a force F1 to the right on pivot connection 30 of the levers 24. Simultaneously a force F2 will be imposed to the left by the links 36 from the axle on the pivot 38 of the small arm of the lever 24. These forces will impose a clockwise rotation or pivoting of the lever 24 about its pivot point or joint 30 thereby imposing a downward force F3 on the right-hand spring as viewed in FIG. 4, and an upward force on the pivot pin 32 of the left-hand lever 24. This action will simultaneously load the compression spring 18 on the right and unload the compression spring 18 on the left counteracting the tendency of the body of the vehicle to roll to the right.

As will be appreciated, compression springs increase in resistance with increasing displacement. Therefore the greater displacement of the spring on the right increases the lift or support by that spring of the vehicle body. Simultaneously the extension of the spring on the left reduces the lift or support by that spring and simultaneously allows the left side of the body to remain in place or drop down thus reducing the roll of the body to the right. This results in a counteraction of the tendency of the vehicle to roll and thereby maintains the vehicle body or chassis substantially level as the vehicle goes through a turn. The response of the suspension to bumps or obstacles and depressions in the roadway is similar and maintains the vehicle body in a level condition.

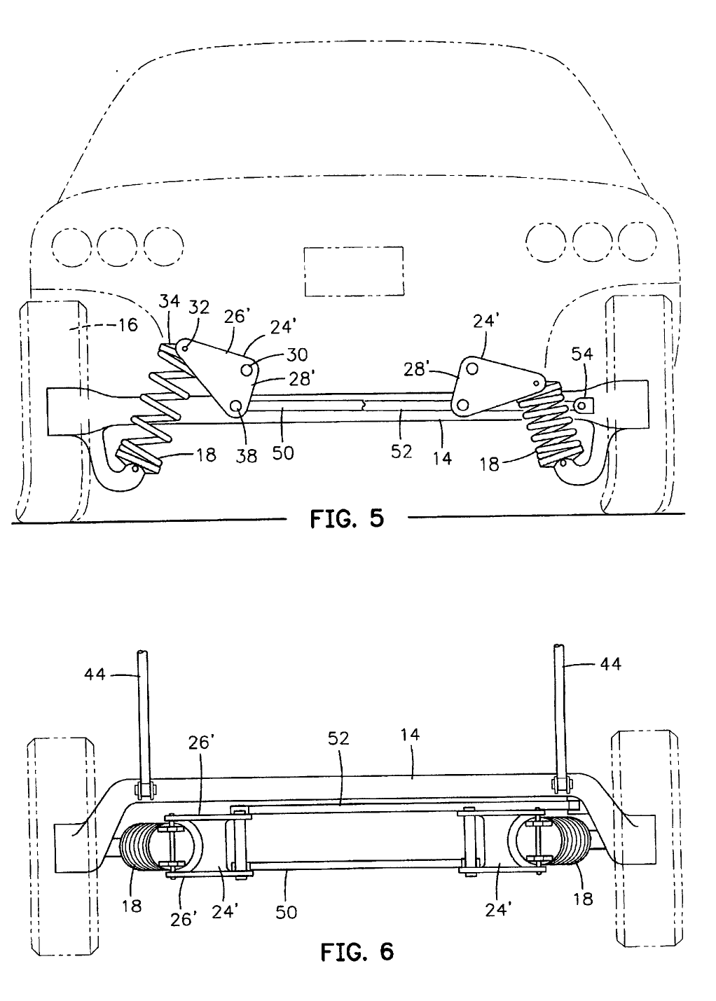

Referring the FIGS. 5 and 6 an alternate embodiment of the invention is illustrated wherein most of the major components are identical and identified by the same reference numerals as in the prior embodiment. Modified components are identified by the same numeral primed. As illustrated, the axle and spring support assembly are substantially identical as in the prior embodiment. The levers or bell cranks however, are slightly modified and as illustrated at 24′ are symmetrical with two parallel short arms 28′. In this embodiment the linkage interconnection of the suspension levers with the axle of the vehicle differ in that the two levers 24′ are tied together by a tie bar or link 50 between arms 28′ tying them together to rotate together. The short arm 28′ of one of the brackets, the left-hand bracket in the illustrated embodiment, is connected by a Panhard link 52 to a pivot pin 54 on the right-hand end of the axle 14. Thus shifting of the vehicle chassis in response to a curve imposes that movement on the linkage system, which acts to counter any tendency to roll.

This embodiment of the suspension system, as illustrated in FIGS. 5 and 6, reacts and functions in resisting the roll of the vehicle as in the prior embodiment. As the vehicle enters a left turn the chassis of the vehicle shifts towards the right thereby imposing a force to the right on pins 30 with link 52 applying a force to arm 28 of bracket 24′ on the left side of the vehicle rotating it clockwise. This forces rotation of both brackets through linkage 50 tying the arms of the levers 24′ to rotate together. This, as in the prior embodiment, compresses and loads the spring 18 on the right or down load side of the chassis and simultaneously extends or unloads spring 18 on the left side or up load side of the vehicle thereby resulting in the vehicle chassis remaining substantially level as the vehicle passes through a turn.

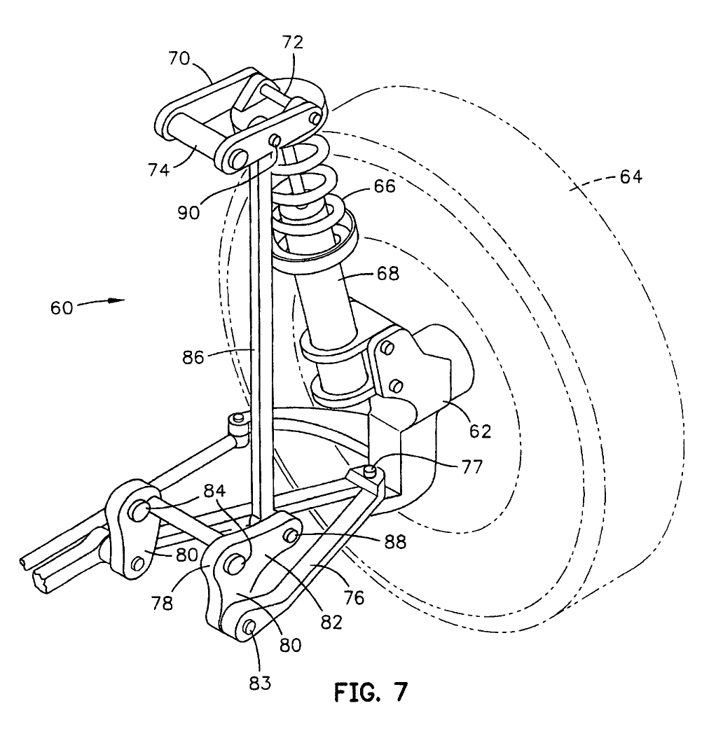

Referring to FIG. 7 of the drawings a perspective view of a suspension system for one side of the front of a vehicle accordance with the invention is illustrated. This system works on the same basic principle as that of the previously discussed embodiments. This embodiment designated generally by the numeral 60 illustrates a steerable independent front suspension system wherein wheel mounting axle assemblies 62 mount a pair of laterally spaced front wheels 64 shown in phantom. The axle, as illustrated, is connected to a vehicle by means of a McPherson strut including a coil compression spring 66 and a hydraulic damping cylinder assembly 68. The strut is connected or attached at the lower end to axle 62 and at the upper end to an upper lever or arm 70 at a pivot pin 72. The upper lever is pivotally connected by a suitable pivot pin or the like at 74 to the chassis or body of a vehicle. A lower control arm assembly or unit 76 is connected at an outer end by pivot pin 77 to the wheel axle assembly 62 and at an inner end by pin 83 to a bell crank type lever 78 which is attached at a pivot 84 to the vehicle chassis. Bell crank 78 is formed with two spaced apart parallel short arms 80 and a long arm 82. Lower control arm 76 is pivotally attached at pin 83 to short arm 80 of lever or bell crank 78. Bell crank 78 is pivotally attached by pin 84 to the chassis. An actuating or compensating link 86 is pivotally connected at 88 to the lower arm 82 of bell crank 78 and at 90 to the upper lever or arm 70.

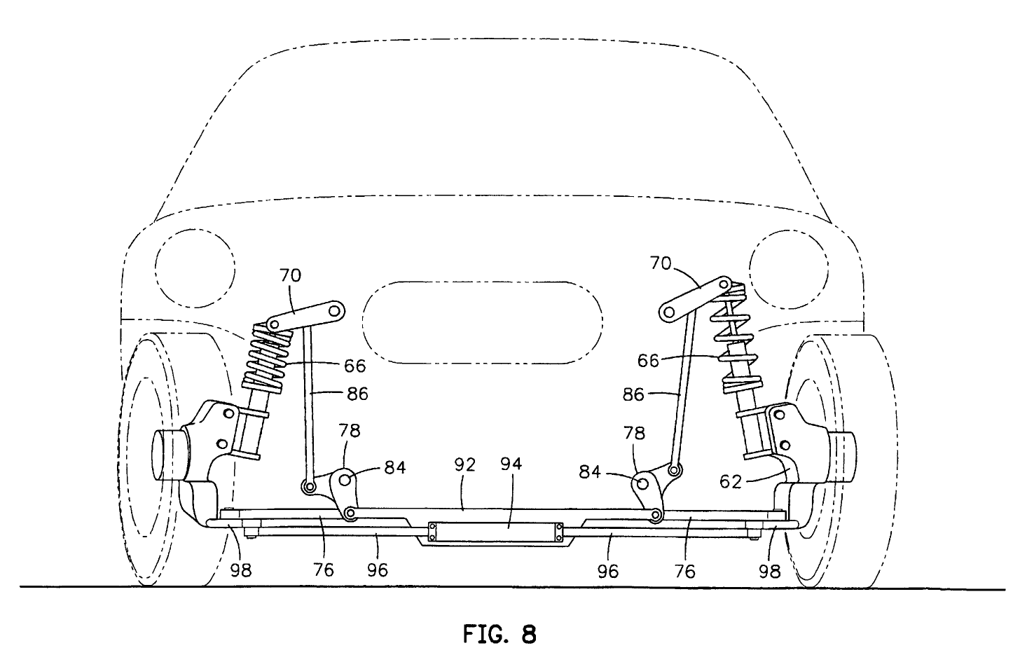

Referring to FIG. 8 it will be seen that the suspension system wheel assemblies are tied together by a tie link or bar 92 and will function substantially as the prior system when the vehicle is in a turn. As shown in FIG. 8 the vehicle, shown in a left turn, remains substantially level as the suspension system functions as previously described with respect to the prior embodiment. As illustrated the vehicle will tend to move to the left as viewed in FIG. 8 imposing a force on pivots 84. This force by the vehicle chassis will attempt to force the levers 78 to the left relative to the wheels. The lever 78 is tied to the wheels by the lower arm 76 and by link 92 so that the force causes the link to rotate as illustrated pulling downward on link 86 at the left side of the vehicle and pulling lever 70 downward compressing the spring 66 on the left or down load side. This loads the spring 66 supporting the weight of the vehicle while the spring 66 on the right up load side is extended thus allowing the vehicle body to remain level.

A steering box 94 is attached to and carried by tie bar 92 connected between the levers 78 of the two front wheel assemblies. The steering box may be either hydraulic or rack and pinion and will have the usual connection such as a shaft or hydraulic line (not shown) from the steering wheel. This mounts the steering box to remain and move with the wheels rather than move with the chassis. This avoids the introduction of movement of the chassis into the steering of the wheels.

While certain preferred embodiments have been described above, it is to be understood that a latitude of modification and substitution is intended in the foregoing disclosure, and that these modifications and substitutions are within the literal scope, or are equivalent to the claims that follow.

Accordingly, it is appropriate that the following claims be construed broadly and in a manner consistent with the spirit and scope of the invention herein described.

I claim:

1. An anti-roll suspension for a vehicle chassis having at least two laterally spaced wheels, the suspension comprising:
an axle assembly for rotatably mounting each of a pair of laterally spaced wheels;
a spring assembly supporting the chassis on each of the axle assemblies;
a moveable arm connected between the spring assembly and the chassis; and
an anti roll linkage connected to said chassis and to said moveable arm, and structured to translate lateral movement of the chassis to vertical movement of said moveable arm to the spring on the down force side of the chassis so that the anti roll linkage simultaneously lifts the down force side of the chassis and lowers the up force side of the vehicle.

2. An anti-roll suspension according to claim 1 wherein said moveable arm comprises a bell crank for pivotal mounting to a vehicle chassis having one arm connected to one end of said spring assembly, and another arm connected to a compensating link receiving and translating said lateral movement.

3. An anti-roll suspension according to claim 2 wherein said compensating link is connected to at least one of said axle assemblies.

4. An anti-roll suspension according to claim 2 wherein said spring is a coil compression spring normally disposed in a substantially vertical orientation.

5. An anti-roll suspension according to claim 4 wherein said axle assemblies are embodied on opposite ends of an elongated rigid axle wherein said second link is connected to a lower portion of said spring assembly.

6. An anti-roll suspension according to claim 5 wherein said compensating link is connected at one end to said axle.

7. An anti-roll suspension according to claim 6 wherein:
said compensating link is connected at one end to one axle assembly; and
a tie link is connected between arms of said lever of each suspension assembly.

8. An anti-roll suspension according to claim 5 wherein each suspension assembly includes one said compensating link connected at one end to said axle assembly.

9. An anti-roll suspension according to claim 3 wherein:
said axle assemblies are steerable; and
each suspension assembly includes a bell crank mounted on the chassis and one said compensating link connected at one end to said bell crank.

10. An anti-roll suspension according to claim 9 wherein each of said axle assemblies are independently supported on said chassis.

11. An anti-roll suspension according to claim 10 wherein each of said spring assemblies embodies a McPherson strut.

12. An anti-roll suspension according to claim 3 wherein each of said spring assemblies embodies a McPherson strut.

13. An anti-roll suspension system for a vehicle chassis having at least two laterally spaced front wheels and two laterally spaced rear wheels, the suspension comprising:
an axle assembly for mounting each of a pair of laterally spaced front wheels;
an axle assembly for mounting each of a pair of laterally spaced rear wheels wheels;
a spring assembly for mounting each of the axle assemblies to the chassis;
a moveable arm connected between each spring assembly and the chassis; and
an anti roll linkage connected to said chassis and to said moveable arm, and said anti roll linkage structured to translate a lateral movement of the chassis to a vertical downward movement of said moveable arm to the spring on the down force side of the chassis and a vertical upward movement of said moveable arm to the spring on the up force side of the chassis so that the anti roll linkage simultaneously lifts the down force side of the chassis and lowers the up force side of the vehicle.

14. An anti-roll suspension system according to claim 13 wherein said moveable arm comprises a bell crank for pivotal mounting to a vehicle chassis, the bell crank having one arm connected to one end of said spring assembly, and another arm connected to a compensating link receiving and translating said lateral movement.

15. An anti-roll suspension according to claim 14 wherein said compensating link is connected to at least one of said axle assemblies.

16. An anti-roll suspension according to claim 15 wherein said spring is a coil compression spring normally disposed in a substantially vertical orientation

17. An anti-roll suspension according to claim 16 wherein each of said axle assemblies are independently supported on said chassis.

18. An anti-roll suspension according to claim 17 wherein each of said spring assemblies embodies a McPherson strut.

19. An anti-roll suspension according to claim 15 wherein each of said spring assemblies embodies a McPherson strut.

20. An anti-roll suspension according to claim 19 wherein:
said anti roll linkage is interconnected to between said front wheels by a tie link; and
a steering box for said front wheels is mounted on said tie link.
